(19) United States
(12) Patent Application Publication
(10) Pub. No.: US 2007/0230303 A1
(43) Pub. Date: Oct. 4, 2007

(54) System of adjusting tilt angle of disc driver and adjusting method thereof

(76) Inventors: Hong-Chi Chen, Fongshan City (TW); Chi-Yu Tsang, Toufen Township (TW)

Correspondence Address: LOWE HAUPTMAN BERNER, LLP, 1700 DIAGONAL ROAD, SUITE 300, ALEXANDRIA, VA, 22314, US

(21) Appl. No.: 11/396,683

(22) Filed: Apr. 4, 2006

(51) Int. Cl. G11B 11/00

(52) U.S. Cl. 369/53.19

(57) ABSTRACT

A system of adjusting tilt angle of a disc driver includes a disc driver having a motor, a disc loading seat, a guide rod, a pick-up head moveably assembled with the guide rod, a guide rod mirror assembled with the guide rod, and an adjusting member for adjusting the guide rod. The system further includes a processor, a collimator electrically connected to the processor for sending a position signal to the processor after detecting the guide rod mirror, an information reader for obtaining a tilt angle of the pick-up head and then sending a target signal to the processor, and a screen electrically connected to the processor. The processor will export an adjusting image on the screen after obtaining and dealing with the position signal and the target signal.

### BACKGROUND OF THE INVENTION

1. Field of the Invention

The present invention relates to a system of adjusting tilt angle of a disc driver and relates to a method to adjust the tilt angle of the disc driver, especially to a system of adjusting the tilt angle of a pick-up head in a disc driver and a method thereof, for improving the ability of reading or writing of the disc driver.

2. Description of the Related Arts

Disk drivers are widely used as storage mediums because of the speedy increase of capability and efficiency. And the disc driver is a major technology applied to write and read information.

In a conventional disc driver, a pick-up head is a basic component, and is also a bottleneck of development or manufacturing. The pick-up head can determine or affect the development of efficiency of the disc driver. During manufacturing and assembling, tolerance is unavoidable when the manufacturer assembles a pick-up head with other components, which will affect the writing or reading efficiency of the disc driver. Some of the affecting factors are cited hereinafter. Firstly, after the pick-up head is assembled with the disc driver, the tilt angle of the pick-up head relative to the disc is improper because of the manufacturing tolerance of the pick-up head, which will affect the writing or reading efficiency of the disc driver. Secondly, the tilt angle of the pick-up head relative to the disc will be changed by reason of the sympathetic vibration produced by the rotation of the disc driver, which will also affect the writing or reading efficiency of the disc driver. Data density of an early disc driver is generally quite low, and early disc driver was only provided with reading function. As a result, the lower efficiency of the early disc driver could be accepted. However, data density of a modern disc driver is several times higher than that of the early disc driver, and writing function is needed for enabling higher data density. Therefore, the writing or reading efficiency of the disc driver must be improved.

A method, as disclosed in Taiwan Patent NO. 1229858, is brought to solve the problem mentioned above. The method is to detect a mirror of a rotating plate in a disc driver using a collimator. After that, a bright dot is shown on a screen, the dot being exported by a switch. At the same time, a bar code reader is used to obtain the tilt angle of the pick-up head provided by the manufacturer, for exporting another bright dot on the screen via a host. To adjust the tilt angle of the pick-up head, a user should observe the dot exported by the switch and alternatively observe the dot exported by the host. During observation, the user should rectify the tilt angle till the two dots overlaps each other. By this way, the above-mentioned problem may be solved. However, at least one switch is needed in this solution to switch the dots exported by the host and the collimator, which is inconvenient and increases the cost of the system. In addition, the adjusting process is generally operated manually or by an electro-controlling mode, which increases the complexity of operation and even affects the efficiency or efficacy of adjusting.

According to the above-mentioned issues, a system of adjusting tilt angle of a disc driver and a method thereof, enabling both high efficiency and lower cost, are desired.

### SUMMARY OF THE INVENTION

A major object of the present invention is to provide a system of adjusting tilt angle of a disc driver, the system enabling lower cost and enabling high precision in adjusting process.

Another object of the present invention is to provide a method to adjust the tilt angle of the pick-up head of the disc driver.

According to the present invention, a system of adjusting tilt angle of a disc driver is provided to resolve the disadvantages mentioned-above. The system includes a disc driver having a motor, a disc loading seat, a guide rod, a pick-up head moveably assembled with the guide rod, a guide rod mirror assembled with the guide rod, and an adjusting member for rectifying the guide rod. The pick-up head can move relative to the guide rod back and forth. The system further includes a processor, a collimator electrically connected to the processor for sending a position signal to the processor after detecting the guide rod mirror, an information reader for obtaining a tilt angle of the pick-up head and then sending a target signal to the processor, and a screen electrically connected to the processor. The processor will export an adjusting image to the screen after obtaining and dealing with the position signal and the target signal.

According to the above-described invention, a dot is shown on the screen after the position signal is operated by the processor.

According to the above-mentioned invention, a dot or a range is shown on the screen after the target signal is operated by the processor, wherein the range is a rectangle or a circle.

According to the above-mentioned invention, the disc driver further includes a motor mirror on the disc loading seat, and the collimator can sending a balance signal to the processor after detecting the motor mirror to show a dot or a circle on the screen for judging the counterbalance of the rotation of the disc loading seat driven by the motor.

According to the above-mentioned invention, the present invention provides a method of adjusting tilt angle of a disc driver, for adjusting the tilt angle of a pick-up head of the disc driver. Steps of the method comprise: providing an information reader for obtaining a tilt angle of the pick-up head and then sending a target signal to a processor, providing a collimator for detecting a guide rod mirror and then sending a position signal to the processor, sending an adjusting image to a screen, the adjusting image being produced by the processor after operating the position signal and the target signal, and rectifying an adjusting member using the adjusting image for change the tilt angle of the pick-up head.

According to the above-mentioned invention, the step of rectifying the adjusting member is completed while the dot produced by the position signal superposes the dot produced by the target signal.

According to the above-mentioned invention, the step of rectifying the adjusting member is completed while the dot produced by the position signal is within the range produced by the target signal.

According to the above-mentioned invention, a method of adjusting tilt angle of a disc driver further comprises a step providing a collimator detecting a motor mirror and sending a balance signal to the screen. A balance image is accordingly shown on the screen. If the balance image is a dot, the motor is in a rotation balance status, and if the balance image is a circle, the motor is not in a rotation balance status.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

The present invention will become more apparent from the following detailed description when taken in conjunction with the accompanying drawings, in which:

### BRIEF DESCRIPTION OF THE DRAWINGS

FIG. 1 is a block-illustration of a system of adjusting tilt angle of a disc driver in accordance with a preferred embodiment of the present invention;

FIG. 2 is a flow chart of a method of adjusting tilt angle of the disc driver in accordance with the preferred embodiment of the present invention; and

FIG. 3 is a flow chart of a method of adjusting tilt angle of the disc driver in accordance with another preferred embodiment of the present invention.

### DESCRIPTION OF PREFERRED EMBODIMENT

Reference will now be made to the drawings to describe the present invention in detail.

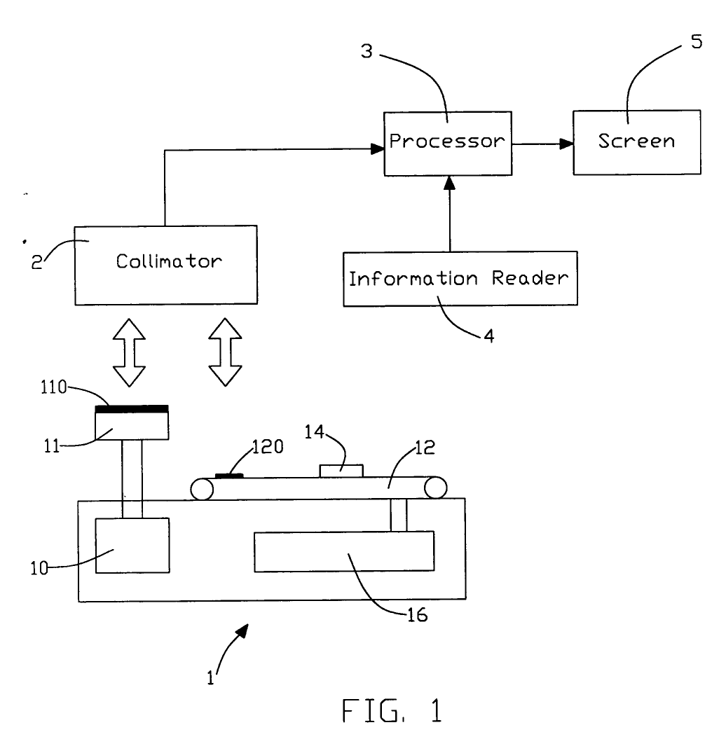

Referring to FIG. 1, which is a block-illustration of a system of adjusting tilt angle of a disc driver in accordance with a preferred embodiment of the present invention, the system of adjusting tilt angle of a disc driver comprises a disk driver 1, a collimator 2, a processor 3, an information reader 4, and a screen 5. The disc driver 1 includes a motor 10, a disc loading seat 11, a guide rod 12, a pick-up head 14, a guide rod mirror 120, and an adjusting member 16. The motor 10 is used to provide power to drive the disc loading seat 11 with a disc (not shown) for the pick-up head 14 to read the information carried by the disc. The collimator 2 is electrically connected to the processor 3 for detecting the guide rod mirror 120 and then sending a position signal to the processor 3. The information reader 4 is used to obtain a tilt angle (not shown) and then sending a target signal to the processor 3. The information reader 4 may be a bar code reader, and the tilt angle information may be presented as bar code. Thus, the bar code reader can obtain tilt information form the bar code and can send a target signal to the processor 3. After receiving the position signal and the target signal, the processor exports an adjusting image (not shown) to the screen 5. Position or angle of the guide rod 12 can be rectified by virtue of the adjusting image and the adjusting member 16. The tilt angle between the pick-up head 14 and the disc can be accordingly changed. The problems of the conventional art are accordingly resolved.

Detailed description is presented hereinafter. The collimator 2 is used to directly detect the position of the guide rod 120 and then send a position signal to the processor 3. A dot is shown on the screen 5 after the position signal is operated by the processor 3. The information reader 4 is used to obtain tilt angle information of the pick-up head 14 and then sending a target signal to the processor 3. Similarly, the target signal is operated by the processor and a dot or a range is shown on the screen 5. The processor 3 is used to collect and operate the position signal and the target signal for showing images on the screen 5. The images shown on the screen are bases, according to which the adjusting member 16 can be rectified. If the image produced by the target signal is a dot, a user or an operator can directly observe the two dots, one produced by the position signal, another produced by the target signal. The user can operate the adjusting member 16 to adjust the position or angle of the guide rod 12. During the operating process, the dot produced by the position signal will move on the screen 5. While the two dots lap over each other, operation to the adjusting member 16 is completed. The tilt angle between the pick-up head 14 and the disc is optimal. If the image produced by the target signal is a range, like a rectangle, a circle or any closed range, a user or an operator can directly observe the dot produced by the position signal and the range. The user can operate the adjusting member 16 to adjust the position or angle of the guide rod 12. During the operating process, the dot produced by the position signal will move on the screen 5. While the dot moves into the range, operation the adjusting member 16 is completed. The tilt angle between the pick-up head 14 and the disc is optimal. Therefore, problems in the conventional art are accordingly resolved.

Further, the disc driver 1 in the present invention can comprises a motor mirror 110 defined on the disc loading seat 11. Thus, when the motor 10 drives the disc loading seat 11 to rotate, the collimator 2 can detect the motor mirror 110 and then sending a balance signal to the processor 3. After being operated by the processor 3, the balance signal can produce a dot or a circle on the screen 5. If the balance signal produces a circle, it is indicated that the rotation is not balanceable and even ramshackle. Adjustment to the disc loading seat 11 or to the motor 10 is necessary. If the balance signal produces a dot, it is indicated that the rotation is balanceable, and the adjusting process mentioned above is confirmed.

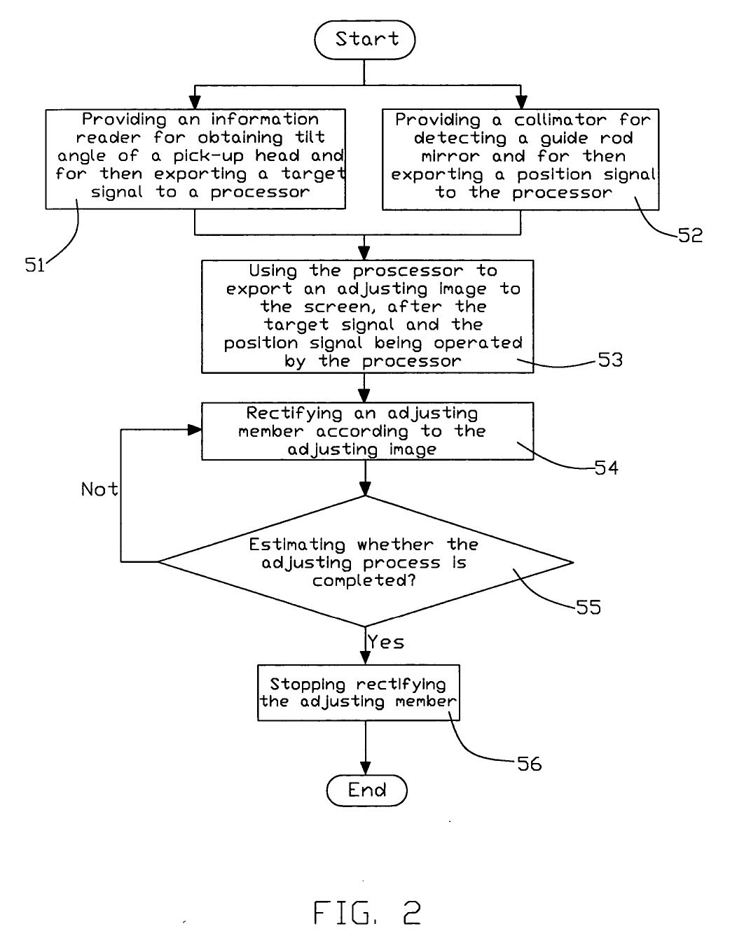

FIG. 2 is a flow chart of a method of adjusting tilt angle of the disc driver in accordance with the preferred embodiment of the present invention. An information reader is used to obtain the tilt angle information of the pick-up head and to export a target signal to a processor, which is illustrated as step 51, wherein the information reader may be a bar code reader and the tilt angle information can be presented as bar code. At the same time, a collimator is used to detect a guide rod mirror and to export a position signal to the processor, which is illustrated as step 52. Following step 52, after the processor acquires the target signal and the position signal, an adjusting image is exported form the processor to a screen, which is illustrated as step 53. The processor will export a dot to the screen after obtaining the position signal, and the processor will export a dot or a range to the screen, wherein the range may be a rectangle or a circle. The dot and the range build up an adjusting image. In this step, the processor is used to operate the position signal and the target signal for showing the dot and the range on one screen. And then, the adjusting image is used to provide reference to a user to adjust an adjusting member, which is illustrated as step 54. In this step, position or tilt angle of a guide rod is adjusted by operating the adjusting member, and the tilt angle of the pick-up head is accordingly adjusted. Following step 54, step 55 can tell if the adjusting procedure is completed. If the target signal produces a dot on the screen, the adjusting procedure is completed after the dot produced by the position signal overlaps the dot produced by the target signal and step 56 described below can be executed. On the contrary, if the dot produced by the position signal does not overlap the dot produced by the target signal, the adjusting procedure is not completed and step 54 should be re-executed. If the target signal produces a range on the screen, the adjusting procedure is completed after the dot produced by the position signal is within the range produced by the target signal and step 56 described below can be executed. On the contrary, if the dot produced by the position signal is beyond the range produced by the target signal, the adjusting procedure is not completed and step 54 should be re-executed. Step 56 is to stopping adjusting the adjusting member. After the adjusting procedure is completed, the tilt angle of the pick-up head relative to the disk is accordant to the requirement of the pick-up head manufacturers, and the pick-up head of the disc driver can achieve the optimal status.

The method of adjusting tilt angle of the pick-up head of the present invention can not only adjusting the tilt angle of the pick-up head for optimizing the tilt angle of the pick-up head, but also can economize the cost because no switcher is needed. And it is easy to realize auto-adjusting process by virtue of intending auto-controlling mode. Potential of industrial applying is more obvious.

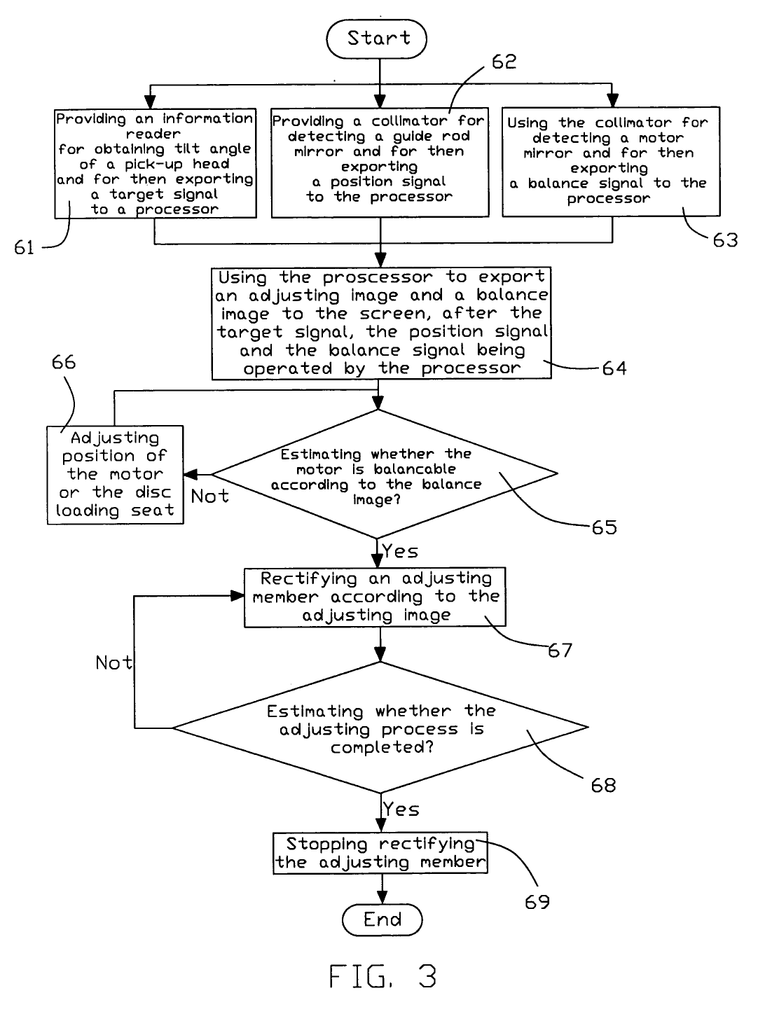

FIG. 3 is a flow chart of a method of adjusting tilt angle of a disc driver in accordance with another preferred embodiment of the present invention. The object of adjusting the tilt angle of the pick-up head is to make the tilt angle of the pick-up head satisfy the predetermined requirement. A motor drives the disk carried by the disc driver. So, the rotation of the disk or the motor should satisfy some requirement. Therefore, this embodiment additionally provides a method to detect the counterbalance of the disk driven by the motor. The method will be described in detail as below.

Steps 61 and 62 are identical to steps 51 and 52. Step 63 is to detect a motor mirror by a collimator and to export a balance signal to the processor. After that, the processor will export an adjusting image and a balance image to the screen after receiving the position signal, target signal and the balance signal, which is illustrated as step 64. A dot will be shown on the screen after the position signal is operated by the processor, and a dot or a range, like a rectangle or a circle, will be shown on the screen after the target signal is operated by the processor, which buildups an adjusting image. After the balance signal is operated by the processor, a dot or a range is shown on the screen. The dot or the range produced by the balance signal is a balance image. Step 65 will tell if the rotation of the motor is balanceable. If the balance image is a circle, the rotation of the disc driven by the motor is not balanceable by reason of vibration, incline or bad assembly, and step 66 should be executed. If the balance image is a dot, the rotation of the disc driven by the motor is balanceable, and step 67 can be executed. Steps 67, 68 and 69 are similar to steps 54, 55 and 56, respectively. Repeated description is omitted.

The method described in the above-mentioned embodiment can not only achieve the above-mentioned advantages in the first preferred embodiment, but also can achieve the performance of detecting the counterbalance of the disc, which enables the pick-up head to satisfy the requirement of tilt angle desired by the pick-up head manufacturers. And the status of the pick-up head can be optimized.

Furthermore, although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A system of adjusting a tilt angle of a disc driver, the system comprising:
a disc driver including a motor having a disc loading seat, a guide rod, a pick-up head moveably assembled with the guide rod, a guide rod mirror assembled with the guide rod, and a adjusting member for adjusting the guide rod;
a processor;
a collimator electrically connected to the processor for detecting the guide rod mirror and then exporting a position signal to the processor;
an information reader for obtaining the tilt angle of the pick-up head and then exporting a target signal to the processor; and
a screen electrically connected to the processor for showing an adjusting image produced by the processor after operating the position signal and the target signal.

2. The system of adjusting a tilt angle of a disc driver as described in claim 1, wherein the information reader is a bar code reader, and the tilt angle of the pick-up head is presented as bar code, which enables the bar code reader to obtain the tilt angle and to export the target signal to the processor.

3. The system of adjusting a tilt angle of a disc driver as described in claim 1, wherein the position signal is shown as a dot on the screen after being operated by the processor.

4. The system of adjusting a tilt angle of a disc driver as described in claim 1, wherein the target signal is shown as a dot on the screen after being operated by the processor.

5. The system of adjusting a tilt angle of a disc driver as described in claim 1, wherein the target signal is shown as a range on the screen after being operated by the processor.

6. The system of adjusting a tilt angle of a disc driver as described in claim 5, wherein the range is a rectangle or a circle.

7. The system of adjusting a tilt angle of a disc driver as described in claim 1, wherein the disc driver further includes a motor mirror mounted on the disc loading seat, and the collimator can detect the motor mirror and then export a balance signal to the processor.

8. The system of adjusting a tilt angle of a disc driver as described in claim 7, wherein the balance signal is shown as a dot or a circle on the screen after being operated by the operator for being used to tell the counterbalance of rotation of the disc driven by the motor.

9. The system of adjusting a tilt angle of a disc driver as described in claim 1, wherein the adjusting member is used to rectify the gradient of the guide rod.

10. A method of adjusting a tilt angle of a disc driver, for adjusting a tilt angle of a pick-up head of the disc driver, comprising:
providing an information reader for obtaining tilt angle information of the pick-up head and for then exporting a target signal to a processor;
providing a collimator for detecting a guide rod mirror and for then exporting a position signal to the processor;
operating the position signal and the target signal using the processor and exporting an adjusting image on a screen; and
adjusting the tilt angle of the pick-up head using the adjusting member according to the adjusting image.

11. The method of adjusting a tilt angle of a disc driver, as described in claim 10, wherein the position signal is shown as a dot on the screen after being operated by the processor.

12. The method of adjusting a tilt angle of a disc driver, as described in claim 11, wherein the target signal is shown as a dot on the screen after being operated by the processor.

13. The method of adjusting a tilt angle of a disc driver, as described in claim 12, wherein the operation of adjusting the adjusting member is completed while the dot produced by the position signal overlaps the dot produced by the target signal, according to the adjusting image.

14. The method of adjusting a tilt angle of a disc driver, as described in claim 11, wherein the target signal is shown as a range after being operated by the processor.

15. The method of adjusting a tilt angle of a disc driver, as described in claim 14, wherein the operation of adjusting the adjusting member is completed while the dot produced by the position signal is within the range produced by the target signal, according to the adjusting image.

16. The method of adjusting a tilt angle of a disc driver, as described in claim 14, wherein the range is a rectangle or a circle.

17. The method of adjusting a tilt angle of a disc driver, as described in claim 10, further comprising:
providing a collimator for detecting a motor mirror and for then exporting a balance signal to the processor;
operating the balance signal using the processor and exporting a balance image on the screen.

18. The method of adjusting a tilt angle of a disc driver, as described in claim 17, wherein the rotation of the disc driven by the motor is balanceable provided that the balance image is a dot, and the rotation of the disc driven by the motor is not balanceable provided that the balance image is a circle.

19. The method of adjusting a tilt angle of a disc driver, as described in claim 10, wherein the information reader is a bar code reader, and the tilt angle of the pick-up head is presented as bar code, which enables the bar code reader to obtain the tilt angle and to export the target signal to the processor.
